(19) United States
(12) Patent Application Publication
(10) Pub. No.: US 2021/0156252 A1
(43) Pub. Date: May 27, 2021

(54) SYSTEM AND METHOD FOR DUCTED VENTILATION

(71) Applicant: MINETEK INVESTMENTS PTY LTD, Sydney, New South Wales (AU)

(72) Inventor: Remy Marcel Sydney Bourcier, New South Wales (AU)

(21) Appl. No.: 16/488,564

(22) PCT Filed: Feb. 22, 2018
(86) PCT No.: PCT/AU2018/050147

§ 371 Date: Aug. 23, 2019

(30) Foreign Application Priority Data
Feb. 23, 2017 (AU) 2017900608
Jul. 28, 2017 (AU) 2017902986

(51) Int. Cl. E21F 1/08; F04D 29/38; F24F 11/75

(52) U.S. Cl. CPC E21F 1/08; F04D 29/384; F05D 2270/3061; F05D 2260/14; F24F 11/75

(57) ABSTRACT

In an aspect, there is disclosed a system for providing ventilation to a ventilated location within a passageway. The system includes: a duct arranged to extend between an inlet location to an outlet location proximate the ventilated location; an axial fan fitted with the duct having an impellor adapted move air between the inlet location and the outlet location a controllable vane located within the duct relatively upstream of the impellor; a sensor located relatively downstream of the impellor adapted to provide a measurement indicative of a volumetric flow rate discharged from the outlet location; and a controller in operative communication with the sensor and the vane, the controller being configurable to determine the volumetric flow rate and control the vane so as to maintain the volumetric flow rate above a pre-determined minimum volumetric flow rate. Other examples of the system and associated methods are also disclosed.

### RELATED APPLICATIONS

This application claims priority from Australian provisional patent no. 2017900608 filed on 23 Feb. 2017 and Australian provisional patent no. 2017902986 filed on 9 Jul. 2017, the contents of which are incorporated by reference.

### TECHNICAL FIELD

The invention relates to a system and method for ducted ventilation, more particularly, the invention relates to a system and method for operation of a high output axial fan such an impulse bladed axial fan within a duct to ventilate a passageway, tunnel underground roadway, building space or the like where space is at a premium.

### BACKGROUND

Ducted ventilation systems are used to provide additional airflow in a variety of applications such as in tunnels, passageways, buildings and in underground mining. Current industry practice for ventilation in restrictive spaces is to use fixed pitch axial fans. These are available in single stage, two-stage and three-stage arrangements, and operate at constant pitch and constant speed.

As the airflow distance required increases, the need for fan capacity & numbers must increase to provide airflow to maintain the minimum ventilation & safety requirements. As the resistance increases, the pressure rises and the flow rate reduces. This is a problem, as a fixed or minimum volume of air at the end of the duct or throw, regardless of the distance to maintain safety of personnel and machinery.

To accommodate this, current practice is to initially provide more air than is required, knowing that as the lengths increase the volume flow will drop. This means that when the fans are providing more air than required, this is wasting power. Considering the number of fans in operation in a typical system, this power wastage can be a substantial drain on neighbouring infrastructure and a large power cost.

Another method in use is to add additional stages to the fans as the lengths increase. However, the site work required to install a second or third stage makes this an expensive option both in unit costs, services and downtime, again there will be periods of time where the fans are providing more air than required and using more power.

Another problem relates to temporary blockages or flow resistance to egressing air from the duct that result in lower airflow volume to the in tunnels, passageways, buildings—and, in some cases the air flow volume dropping below the required air flow volume.

The invention disclosed herein seeks to overcome one or more of the above identified problems or at least provide a useful alternative.

### SUMMARY

In accordance with a first broad aspect there is provided, a system for providing ventilation to a ventilated location within a passageway, the system including: a duct arranged to extend between an inlet location to an outlet location proximate the ventilated location; an axial fan fitted with the duct having an impellor adapted move air between the inlet location and the outlet location; a controllable vane located within the duct relatively upstream of the impellor; a sensor located relatively downstream of the impellor adapted to provide a measurement indicative of a volumetric flow rate discharged from the outlet location; and a controller in operative communication with the sensor and the vane, the controller being configurable to determine the volumetric flow rate and control the vane so as to maintain the volumetric flow rate above a pre-determined minimum volumetric flow rate.

In an aspect, the sensor is located at or proximate an outlet of the duct.

In another aspect, the sensor is adapted to measure flow velocity and the controller is configured to calculate the volumetric flow rate based on the diameter of the duct.

In yet another aspect, the sensor is or includes a pitot tube or annubar.

In yet another aspect, the impellor is an impulse bladed impellor.

In yet another aspect, each of the blades of the impellor has a substantially constant thickness.

In yet another aspect, the diameter of the impellor is substantially similar to that of the duct.

In yet another aspect, the controllable vane is provided in the form of a plurality of radial vanes located immediately upstream of the impellor, the plurality of radial vanes being pivotally moveable via an actuator in operative communication with the controller.

In yet another aspect, the plurality of radial vanes are controllably moveable to an angle to generate a pre-swirl of airflow in a same direction as a rotation direction of the impellor thereby reducing the volumetric flow rate.

In yet another aspect, the plurality of radial vanes are controllably moveable to an angle to generate a pre-swirl of airflow in an opposing direction to a rotation direction of the impellor thereby increasing the volumetric flow rate.

In yet another aspect, the impellor speed is constant.

In yet another aspect, the impellor speed is predetermined and constant.

In yet another aspect, the controllable vane is able to be angled between a range of about plus 30 degrees to minus 30 degrees.

In accordance with a second broad aspect there is provided, a system for providing ventilation to a ventilated location within a passageway, the system including: a duct arranged to extend between an inlet location to an outlet location proximate the ventilated location; an axial fan fitted with the duct having an impellor adapted move air between the inlet location and the outlet location, the impellor being arranged to operate at a fixed rotational speed; a controllable vane located within the duct relatively upstream of the impellor; a sensor located relatively downstream of the impellor adapted to measure a flow velocity within the duct toward the outlet location; and a controller in operative communication with the sensor and the vane, the controller being configurable to determine the volumetric flow rate based in the flow velocity and control the vane to maintain the volumetric flow rate above a pre-determined minimum volumetric flow rate whilst maintaining the impellor at the fixed rotational speed.

In accordance with a third broad aspect there is provided, a system for providing a ventilation flow between a first location in a passageway and a second location in the passageway, the system including: a duct arranged to extend between an inlet location and an outlet location proximate the first location; an axial fan adapted to move air between the inlet location and the outlet location so as to generate the ventilation flow in the passageway between the first location and the second location; a controllable vane located within the duct relatively upstream of the axial fan; a sensor located relatively downstream of the axial fan within the duct, the sensor being adapted to provide a measurement indicative of volumetric flow rate, and a controller in operative communication with the vane and the sensor, wherein the controller and sensor are configured such that in the presence of the object between the first location and the second location a change in volumetric flow rate is detectable by the sensor indicative of the presence of the object and the vane is actuable to maintain the volumetric flow rate between the first location and second location above a pre-determined minimum volumetric flow rate.

In accordance with a fourth broad aspect there is provided, a method for providing ventilation to a ventilated location within a passageway, the method including: measuring, relatively down stream of an axial fan within an air supply duct arranged to supply ventilation to the passageway, a parameter indicative of a volumetric flow rate discharged to the ventilated location; and selectively moving a control vane located relatively upstream of the axial fan the vane so at to maintain the volumetric flow rate above a pre-determined minimum volumetric flow rate.

In accordance with a fifth broad aspect there is provided, a method for providing ventilation to a ventilated location within a passageway, the method including: measuring, using a sensor located relatively down stream of an axial fan within an air supply duct arranged to supply ventilation to the passageway, a parameter indicative of a measured volumetric flow rate discharged to the ventilated location; determining, using at least one of the sensor and a control system, based on the parameter, the measured volumetric flow rate; comparing, using the control system, the measured volumetric flow rate with a pre-determined minimum volumetric flow rate; and operating a control vane in operative communication with the control system, the control vane being located relatively upstream of the axial fan within the supply duct so as to maintain the volumetric flow rate above a pre-determined minimum volumetric flow rate.

In accordance with a sixth broad aspect there is provided, a method for maintaining a pre-determined volumetric ventilation condition to a closed end of a passageway in the presence of a removable object in the passageway located between the closed end and an open end of the passageway, the method including: supplying ventilation air using a duct having a ducted axial fan arranged to discharge air proximate the first location toward a closed end of the passage, measuring, using a sensor located relatively downstream of the axial, a flow parameter usable to determine a measured volumetric flow rate discharged to the first location; determining, using at least one of the sensor and a control system, based on the parameter, the measured volumetric flow rate, a change in the measured volumetric flow rate being indicative of the removable object being at least one or removed and located between the first location and the second location; comparing, using the control system, the measured volumetric flow rate with the pre-determined volumetric ventilation including a predetermined minimum and maximum volumetric flow rates; and operating a control vane in operative communication with the control system, the control vane being located relatively upstream of the axial fan within the supply duct so as to maintain the volumetric flow rate substantially the pre-determined minimum and maximum volumetric flow rates.

In accordance with a seventh broad aspect there is provided, a method for providing ventilation to a ventilated location within a passageway, the method including: providing a duct arranged to extend between an inlet location to an outlet location proximate the ventilated location; providing an axial fan within the duct adapted move air between the inlet location and the outlet location; measuring, with a sensor located relatively downstream of the axial fan, a flow conditions usable to determine volumetric flow rate discharged from the outlet location; moving a controllable vane located within the duct relatively upstream of the axial fan so as to maintain the volumetric flow rate above a pre-determined minimum volumetric flow rate.

In accordance with a eighth broad aspect there is provided, a method for providing ventilation to a ventilated location within a passageway, the method including: providing a duct arranged to extend between an inlet location to an outlet location proximate the ventilated location; providing an axial fan within the duct adapted move air between the inlet location and the outlet location; setting, using the control system, a fixed rotation speed of an impellor of the axial fan; measuring, with a sensor located relatively downstream of the impellor, a flow conditions usable to determine volumetric flow rate discharged from the outlet location; moving a controllable vane located within the duct relatively upstream of the impellor so as to maintain the volumetric flow rate above a pre-determined minimum volumetric flow rate.

### BRIEF DESCRIPTION OF THE FIGURES

The invention is described, by way of non-limiting example only, by reference to the accompanying figures, in which;

FIG. 1 is a schematic view of a system for providing ventilation to a mine passageway or tunnel including a duct and a fan arrangement;

FIG. 2a is a more detailed schematic view illustrating the fan arrangement having an upstream controllable vane and a downstream sensor;

FIG. 2b is a simplified block diagram illustrating communication between the fan arrangement, the sensor and a control system having a controller;

FIG. 3 is a flow diagram illustrating a method of providing and operating the fan arrangement within the duct to ventilate a passageway;

FIG. 4 is a chart illustrating duty curves of the fan arrangement and showing an operational zone between lower and upper volumetric flow rate set points;

FIG. 5 is a side sectional view illustrating a fan arrangement;

FIG. 6 is a perspective side sectional view illustrating the fan arrangement;

FIG. 7 is a side exploded parts perspective view illustrating the fan arrangement;

FIG. 8a is a front side perspective view illustrating an impeller of the fan arrangement;

FIG. 8b is a topside side perspective view illustrating an impeller of the fan arrangement;

FIG. 8c is a front view illustrating the impeller;

FIG. 8d is an end view illustrating a blade of the impeller;

FIG. 9 is a front view illustrating the blade of the impeller showing section A-A toward the tip and section D-D toward the root;

FIG. 10 is an end view illustrating section A-A as indicated in FIG. 9;

FIG. 11 is an end view illustrating section D-D as indicated in FIG. 9;

FIG. 12 is an example of a power/volume curve comparison the fan arrangement with a comparable duty two-stage axial fan; and

FIG. 13 is an example of a noise/volume curve comparison of the fan arrangement with a comparable duty two-stage axial fan.

### DETAILED DESCRIPTION

### The System & Method

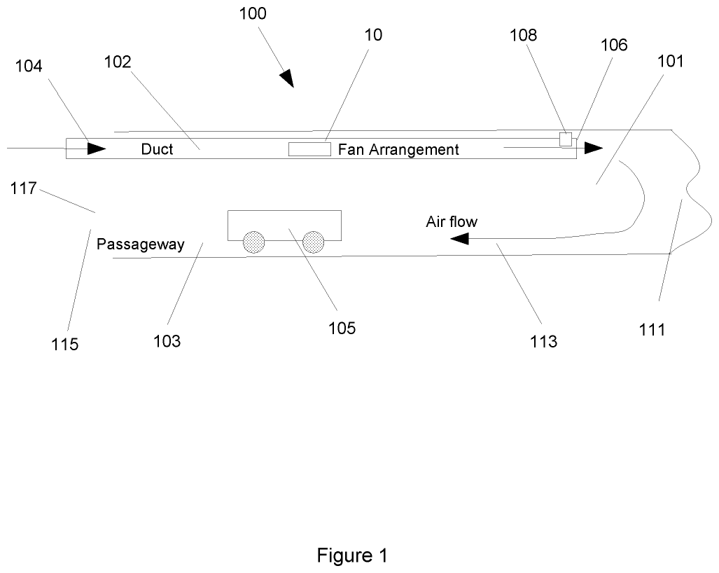

Referring to FIGS. 1 to 3, there is shown a system 100 for providing ventilation to a ventilated location 101 within a passageway 103 such as a roadway, tunnel, shaft, mine passage or the like. The system 100 includes a duct 102 arranged to extend between an inlet location 104 to an outlet location 106 proximate the ventilated location 101. Objects 105 such as vehicles, machines, structures or persons may be present in the passageway 103 which cause resistance to the airflow.

The inlet location 104 may be located proximate an external environment to draw fresh air therefrom and the duct 102 may be relatively long, say 50 to 500 metres or more. The outlet location 106 may be at or proximate the ventilated location 101 which may be an underground location near a current end 111 of the passageway 103. The object 105 may be located between a first location 113 toward the ventilated location 101 and a second location 115 to toward an open end 117 of the passageway 103. It is noted the subject system 100 is not limited to only these applications and may find other applications such as in passages in buildings, underground car parks, tunnels etc.

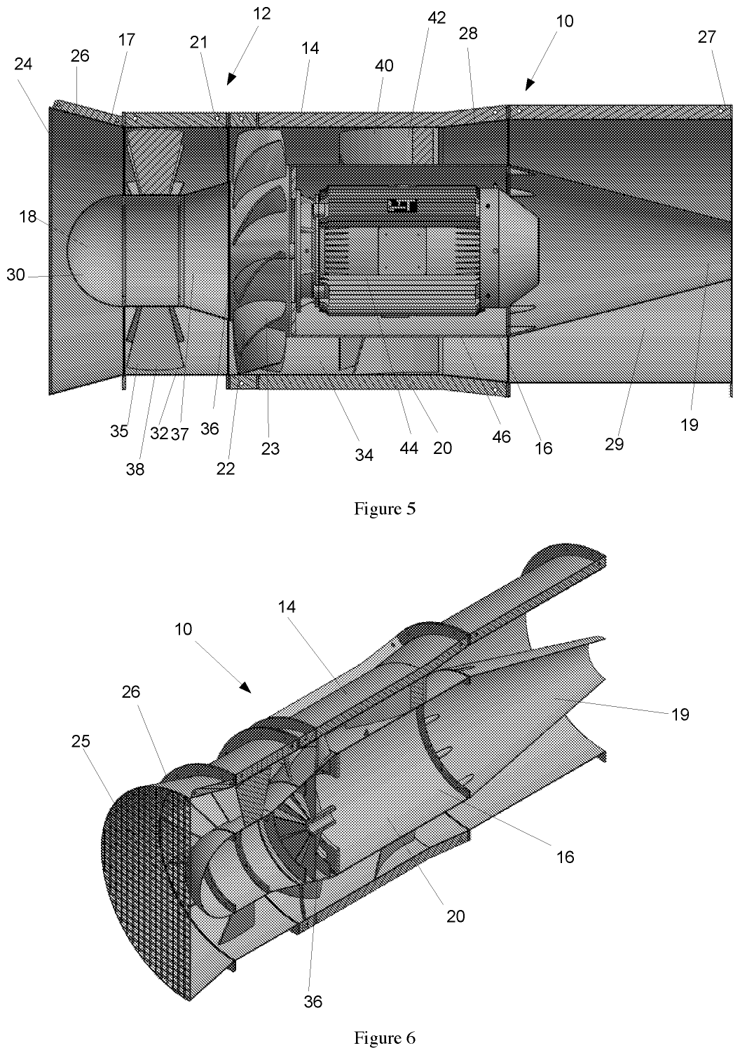

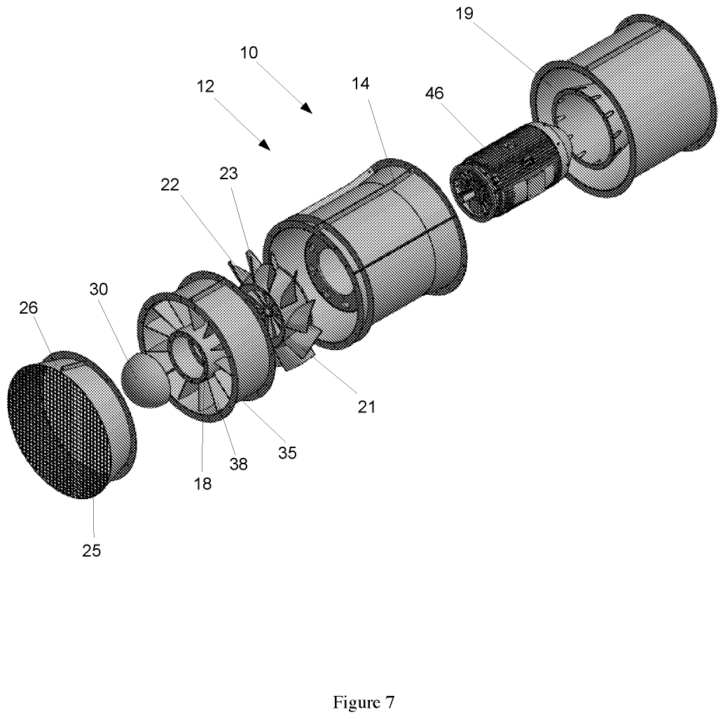

The system 100 includes an axial fan arrangement 10, a sensor 108 located relatively downstream of the axial fan arrangement 10 adapted to provide a measurement indicative of volumetric flow rate discharged from the outlet location 106 and a control system 110 including a controller 112. An example of a suitable axial fan arrangement 10 is described in detail with reference to FIGS. 5 to 11 below. This type of fan is a high output impulse bladed axial fan.

The axial fan arrangement 10 includes an impeller 22 adapted to move air between the inlet location 104 and the outlet location 106, a controllable flow conditioner or flow directing device 35, in this example being operable radial vanes 38, is located within the duct 102 relatively upstream of the impeller 22. The vanes 38 are actuated by an actuator 39 to alter the pitch angle of the vanes 38. The controller 112 is in operative communication with the sensor 108, the vane actuator 39 and a motor 46 that drives the impeller 22. The controller 112 is configurable to control the angles of the vanes 38 so as to maintain the discharged volumetric flow rate above a pre-determined minimum volumetric flow rate and preferably, but not essentially, below a pre-determined maximum volumetric flow rate. The controller 112 may be a PLC (Programmable Logic Controller).

Accordingly, it may be appreciated that the system 100 provides a high output impulse bladed axial fan arrangement 10 with a radial vane control and volume flow measurement to actively regulate the output of the fan arrangement 10. This allows the operator to effectively reduce power consumption consumed yet remain in compliance with regulatory requirements and limits.

Turning to the flow measurement in more detail, in order to regulate the flow, the volumetric flow rate provided by the fan arrangement 10 is determined by measuring the flow velocity using the sensor 108. Accordingly, the sensor 108 may be provided in the form a pitot tube 114 installed at or proximate the outlet 106 of the duct 102 for this purpose. The pitot tube 114 measures the static and total pressure in the duct 102, and the difference between these values provides the velocity pressure which is related to air velocity. An annubar may also be used.

The air velocity is then able to be determined. As the diameter and area of the duct 102 are known as well as the air velocity, the volume flow in m³/s is able to be calculated. By measuring the volumetric flow at the discharge/outlet 106, this allows for any leakage in the duct 102 allowing for greater accuracy in volume delivery.

Turning to the radial control vanes 38, the radial vanes 38 are provided in the form of a series of pivotally adjustable vanes 38 positioned in front of the impeller 22. The vane position can be controlled using the actuator 39, causing the air to swirl in the same direction as the impeller rotation direction (called pre-swirl). This pre-swirl reduces the output of the impellor 22, and also reduces the power consumption of the fan arrangement 10 by keeping the impeller 22 working within the impeller's higher efficiency envelope. To increase the volumetric flow rate the radial control vanes 38 may be an angled to generate a counter pre-swirl that opposing the direction of rotation of the impellor 22. Accordingly, the direction of pre-swirl relative to the fan rotation allows control of the volumetric flow rate from the impellor 22.

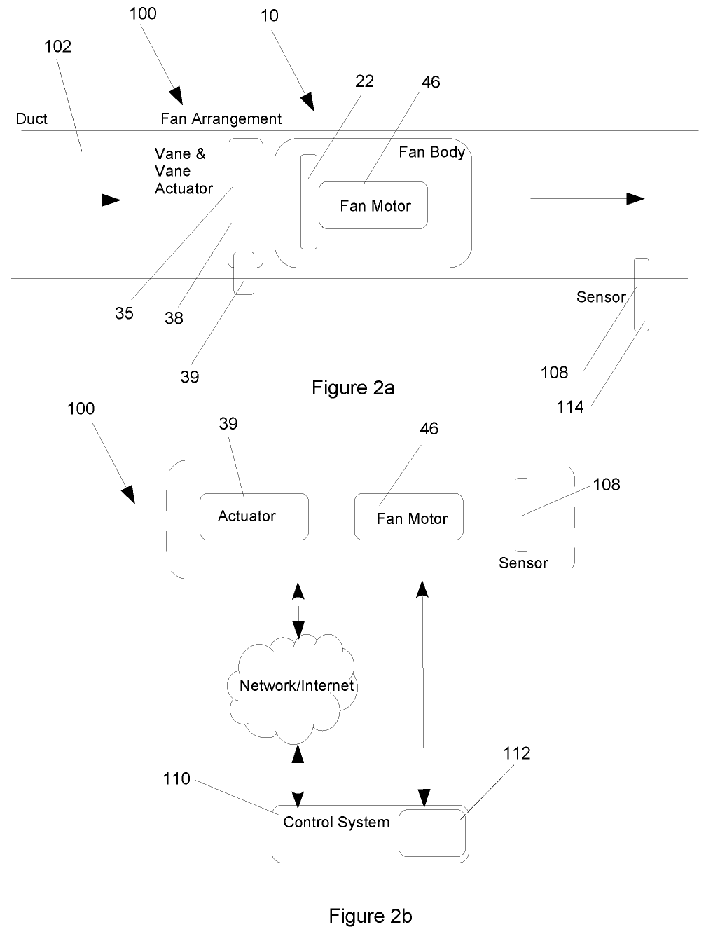

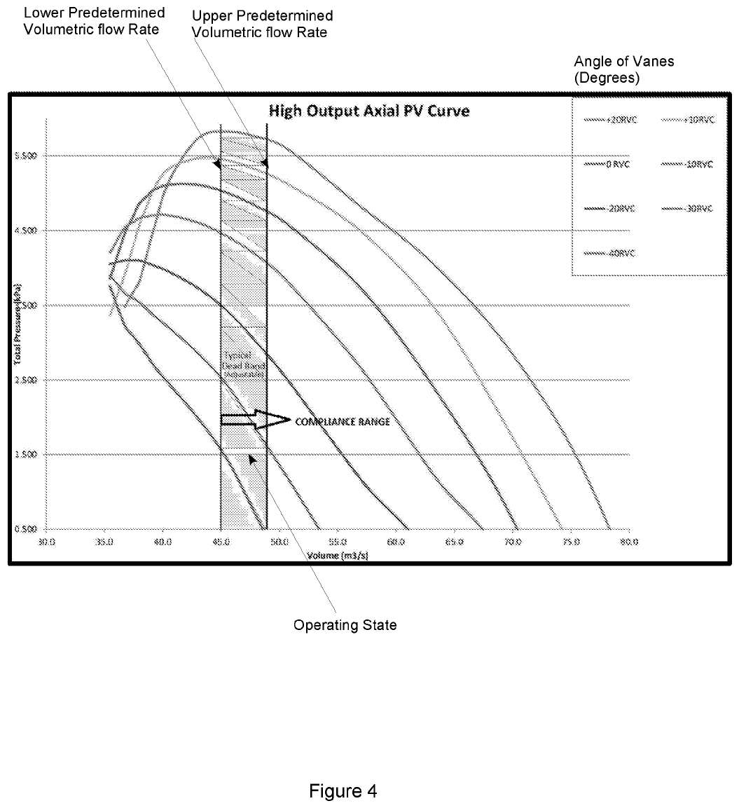

Turning now to the control system 110, the communication between the controller 112, sensor 108, actuator 39 and motor 46 may be wired and/or wireless as shown in FIG. 2b. The operator enters the desired flow rate on a control panel (not shown) of the controller 112 and starts the fan arrangement 10 (if they are not already in operation). In this example, the input includes a predetermined lower or minimum flow rate and a pre-determined upper or maximum flow rate. The operating band or zone is a flow rate generally between the pre-determined minimum and maximum flow rates as shown in FIG. 4.

The fan arrangement 10 starts and accelerates to full speed. It is noted in this example, that the rotation speed of the impellor 22 is constant and in some examples may be set at a 4-pole speed (for example, but not limited to, 1500 rpm) and the duty control is only via the radial vane control 38. However, other set speeds may be used such as other numbers of poles at 50 or 60 Hz.

The volume flow is measured at the discharge or outer 106 of the duct 102, and is compared by the controller 112 with a pre-determined set point within the adjustable band or operating state as shown in FIG. 4. The volumetric flow rate of the adjustable band or operating state may be, but not limited to, in the range of about 40 to 50 m³/s.

If the measured volume flow is below the set point, the radial vane control angle is increased, increasing the output of the fan arrangement 10. If the measured volume flow is above the set point, the radial vane control angle can be decreased, decreasing the output of the fan and the power consumption. If the measured volume flow is close to the set point (within the dead band), no change in radial vane control position is required.

To prevent constant changes in radial vane position, the control system 110 requires volume flow averaging, time delays, and set point dead bands. If the radial vane control is already at its maximum position and the volume flow rate is still below the set point, an alarm can be raised.

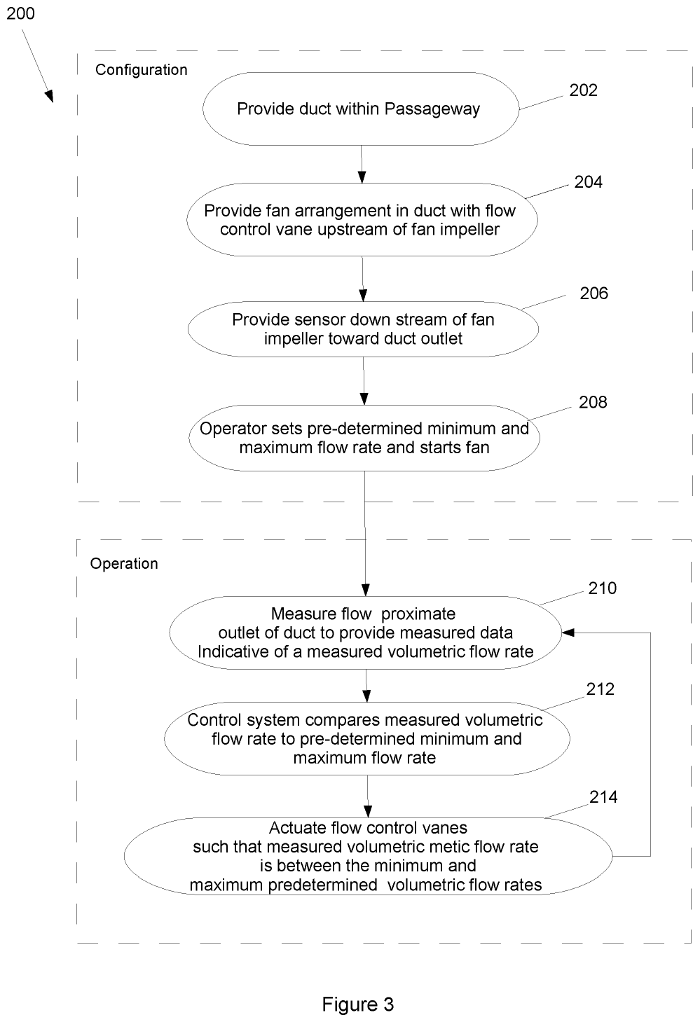

Referring now to FIG. 3, an example method 200 of configuration and operation of the system 100 is shown. The method 200 including, at step 202, providing the duct 102 arranged to extend between the inlet location 104 and the outlet location 106 proximate the ventilated location 101, at step 204 providing the axial fan arrangement 10 within the duct 102 adapted move air between the inlet location 104 and the outlet location 106, and at step 206 providing the sensor 108 located relatively downstream of the axial fan arrangement 10.

At step 208, an operator may set the predetermined minimum and maximum flow rates, and starts the axial fan arrangement 10 with the impellor 22 set to a constant speed. At Step 210, the sensor 108 provides measured data indicative of a measured volumetric flow rate proximate the outlet 106 of duct 102. At step 212, the system 100, namely the control system 110, is configured to compare, the measured volumetric flow rate with the pre-determined minimum and maximum volumetric flow rates, at step 214, the control system 110 is configured to operate the control vane 38 in operative communication therewith so as to maintain the volumetric flow rate above the pre-determined minimum volumetric flow rate and below the pre-determined maximum volumetric flow rate.

During use of the system 100, objects 105 such as vehicles, machines, structures or persons may be present in the passageway 103 which cause resistance to the airflow may lead to a reduction in the volumetric flow delivered to the passageway 103. The resistance to the airflow, for a given control setting of the axial fan arrangement 10, will result in a drop in flow velocity in the duct 102 that will be measurable via the sensor 108 in the form of the pitot tube 114. Accordingly, the system 100 may determine a drop in volumetric flow rate at or proximate the outlet 106 of the duct 102. As such, the system 100 is able to provide a measurement indicative of volumetric flow resistance thereby indicating the presence of the object 105 in the passageway.

When the drop in volumetric flow rate is determined, then the control system 110 is configured to operate the control vanes 38 in operative communication therewith so as to maintain the volumetric flow rate above the pre-determined minimum volumetric flow rate and preferably below the pre-determined maximum volumetric flow rate. Once the objects 105 are removed, the volumetric flow rate will again increase and the control system 110 may then again actuate the control vanes 38 to reduce the volumetric flow rate.

It is noted that the sensor 108, in this example being the pitot tube being at or proximate the outlet 106 of the duct 102 is more sensitive and quicker detect changes in flow velocity and hence volumetric flow rate actually delivered to the ventilated location 101.

### Advantages of the System

Lower power requirements: due to the method of operation the fans will use only the power required. Therefore excessive utilisation of the incoming network is reduced allowing.

Cost savings: as the fans will automatically reduce output and power consumption when possible, this can result in significant efficiency gains and reductions in power consumption without the need of expensive speed control equipment.

Installation cost savings: the installation costs are equivalent to a standard axial fan but because of the wider range of duties that the High Output impulse bladed Axial is far superior to a standard axial, the need for the installation of second and third fan is substantially reduced and eliminated in most cases.

Set and forget: As the control system is automated, there is no need to change the number of stages or make other adjustments to maintain the required volume flow.

Regulation compliance: as the fans can be automatically adjusted, it is far less likely that the volume flow will ever be under the regulative requirements reducing risk to underground workers.

Reduction in impeller fatigue: minimising speed changes is an important point in ventilation on demand systems where every speed change causes the impeller to use its fatigue life and in some circumstances shorten the life of an impeller to less than a year as well as avoid coincidence to the impeller natural frequencies.

### An Example Axial Fan

The above system 100 is preferably configured to operate with the fan arrangement 10 in which the impellor 22 is an impulse bladed impellor meaning that the blades 23 may be non-aerofoil in shape and drive the flow by velocity imparted to the air rather than pressure differentials as is typical of an aerofoil type blade. The impulse bladed impellor is important for the system 100 as the vanes 38 can move through relatively large angles without stalling the impellor 22.

Referring to FIGS. 5 to 13, there is shown a fan arrangement 10 for a duct or system of ducts (not shown) to move or convey air. The fan arrangement 10 includes a housing arrangement 12 having an outer housing 14 and inner housing 16 located within the outer housing 14 so as to define a passageway 17 therebetween. The inner and outer housings 14, 16 may be formed of one or more segments joined with one another.

The inner housing 16 includes a nose section 18, a trailing section 20 and an impeller or fan 22 between the nose section 18 and the trailing section 20. A tail cone 19 is coupled to the trailing section 20 that tapers inwardly toward an axial axis of the housing arrangement 12.

The impeller 22 includes a rotating hub 21 that carries a plurality of likewise rotating blades 23 that extend in a radial direction substantially between the hub 21 and the outer housing 14. The rotating blades 23 each have a substantially flat profile such that the an arrangement 10 may be considered an impulse bladed axial fan in which the impeller 22 drives the airflow by momentum imparted to the air as opposed to a pressure differential as utilised by typical aerofoil ducted axial fans.

The outer housing 14 includes an inlet 24 having an inlet cone 26 adapted to communicate or fluidly couple with the duct and an outlet 27 to re-communicate or fluidly couple with the duct. The inlet cone 26 may be fitted with a grate 25. The outer housing 14 and the inner housing 16 are, at least in part, generally cylindrical in shape and elongate. The outer housing 14 and inner housing 16 are positioned concentrically about the axis of rotation of the impeller 22. The nose section 18 includes a streamlined tip 30 being in this example pointed or domed shaped. The impeller 22 is driven by a motor arrangement 44 having a motor 46 such as, but not limited to an electric motor, adapted to rotate the impeller 22.

A pre-fan section 32 of the passageway 17 is defined between the nose section 18 and the outer housing 14. The pre-fan section 32 thereby having a generally annular shaped cross section through which air passes from the inlet 24 to the impeller 22. A post-fan section 34 of the passageway 17 at the trailing section 20 is defined between the inner housing 16 and the outer housing 14. The post-fan section 34 thereby also having a generally annular shaped cross section through which air passes from impeller 22 towards the outlet 27. The pre-fan section 32 has a relatively larger cross sectional area in comparison to the post-fan section 34. The trailing section 20 may include or terminate with an evasee 28 (an outward tapered diffuser section) prior to an expander section 29 as defined between the tail cone 19 and the outer housing 14.

More specifically, in this example, outer housing 14 has a relatively constant diameter along its length. However, the nose section 18 has a relatively narrower or smaller diameter in comparison to the post-fan section 34 thereby the pre-fan section 32 has a relatively larger cross sectional area in comparison to the post-fan section 34. The hub 21 is shaped to transition between the nose section 18 and the trailing section 20. In this example, the hub 21 is generally truncated frusto-conical in shape to provide a generally straight tapered surface 36 in side profile between the nose section 18 and the trailing section 20. The blades 23 extend radially from the tapered surface 36 of the hub 23. The tapered surface 36 of the hub 21 provides compression of the airflow as it passes through the blades 23 into the outlet section 34. The nose section 18 may include a further likewise tapered section 37 immediately prior to the tapered surface 36 of the hub 21.

The pre-fan section 32 includes a flow conditioner 35 is provided in the form of at least one of a static and adjustable pre-rotator blades 38 that extend radially from the nose section 18 to the outer housing 14. In examples wherein the pre-rotator blades 38 are adjustable, the pre-rotator blades 38 may be used to control the fan characteristics.

The pre-rotator or pre-fan blades 38 guide air to the impeller arrangement 22. The post-fan section 34 includes one or more flow straighteners 40 provided in the form of turning vanes 42 extending radially from the trailing section 20 to the outer housing 14. One or both of the pre-rotator blades 38 and the turning vanes 42 support and suspend the inner housing 16 within the outer housing 14. The housing arrangement 12 may be generally formed of a metal such as mild steel.

Referring to FIGS. 4a to 7, turning now to the impeller 22, in particular the blades 23, each blade includes a twisted blade body 50, a root 52, a tip 54, a leading edge 56 and a trailing edge 58. In this example, each of the blades 23 includes a twist angle between a hub root of the blade and a tip of the blade in the range of about 15 to 30 degrees.

The blade body 50 has a substantially constant thickness across the chord and length. To achieve the constant thickness the blades 23 may be each formed from a metal plate that is twisted to provide the twist angle. The constant thickness plate, being preferably symmetrical in profile and not aerofoil shaped, are resistive to wear and therefore the performance of the fan arrangement may be maintained over time. The constant thickness or flat blades 23 function by increasing velocity imparted to the flow through the impeller 22 without substantially increase of pressure. The constant thickness or flat blades 23 therefore functions differently to an aerofoil shape that relies mainly on a pressure differential to drive the flow. The leading edge 56, trailing edge 58 and tip 54 may be rounded or radiussed to reduce resistance or turbulence.

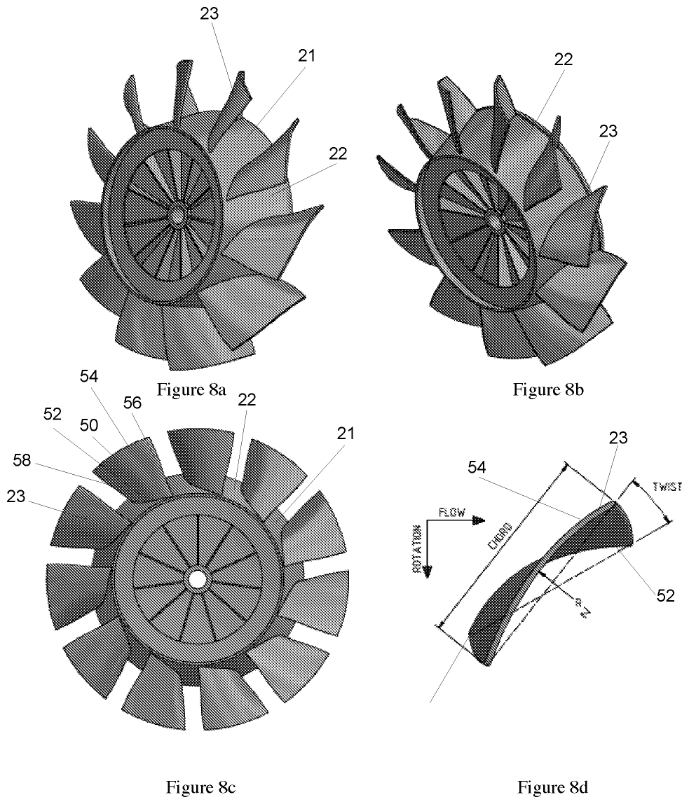

The impeller 22 may be generally formed of a metal such as mild steel. It may be appreciated, in from FIG. 8c, that the blades 23 occupy much of the space through which air flows through the impeller 22. In front plan form view, as shown in FIG. 8c, it may also be appreciated that the leading edges 56 and the trailing edges 58 of adjacent blades 23 are substantially parallel. The blade twist angle is best shown in FIG. 8d and is measured between the blade root 52 and the blade tip 54. The range is about 15 to 30 degrees. However, preferably, the blade twist angle may be about or close to 19 to 23 degrees, and most preferably about 21 degrees.

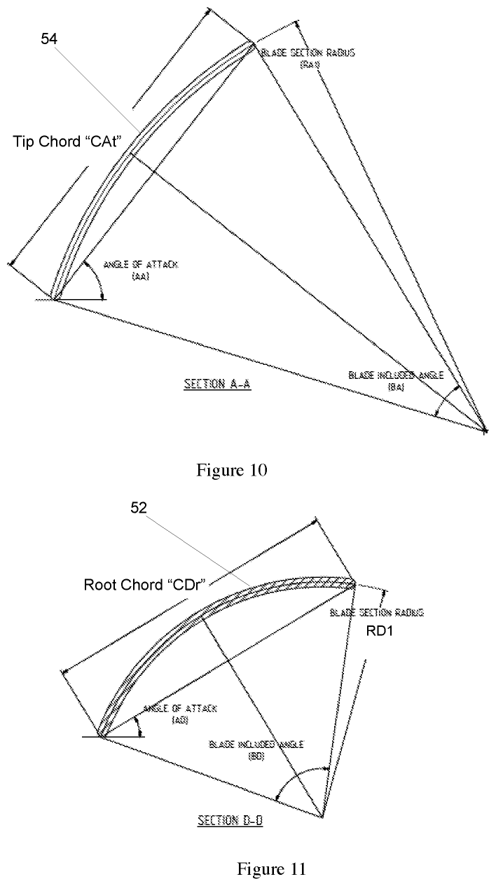

In this example, the chord “CAt” at the tip 54 of the blades 23 is substantially longer relative to the chord “CDr” at the base or root 52 of the blades 23 (best seen by comparing FIGS. 10 and 11). As such, the solidity ratio at the tip “SRt” at Section “A-A” may be in the range of about 0.8 to 1.2, and the solidity ratio “SRr” at Section “D-D” may be in the order of about 1.1 to 1.4. In another unit of measure, it is noted that the aspect ratio (being a ratio of its span or blade length to its mean chord) of the blades is quite low due to the relatively long chord.

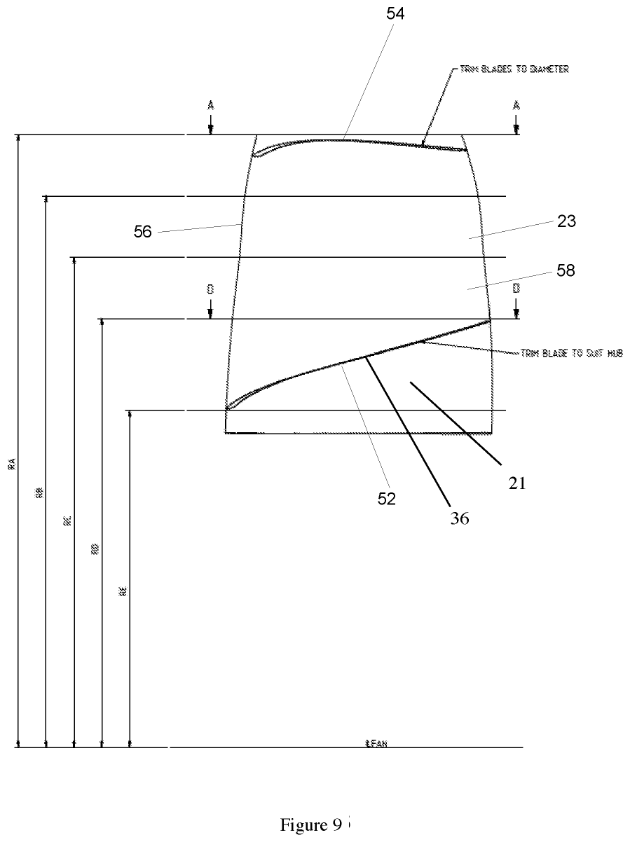

The blade tip solidity ratio “SRt” is defined herein as the sum of the tip chord lengths “CAt” of all blades 23 at tips 54 thereof (i.e. measurement of the chord at section A-A of the blades 23 as shown in FIG. 9) divided by the perimeter at the diameter “D” of the blades 23. By way of example only, the chord width “CAt” of the blade 23 at the tip 54 may be, for example, 350 mm. There may be 11 blades, so 350 mm×11 gives 3850 mm. The diameter “D” may be, for example, 1320 mm. Accordingly, the perimeter is 7C×D which gives 4147 mm. The “SRt” Ratio in this example is=3850/4147=0.93. Other variations of the “CAt” and “D” may be used in the range of about 0.8 to 1.2 as defined above.

Similarly, the blade root solidity ratio “SRr” is defined herein as the sum of the root chord lengths “CDr” of all blades at hub 21 outside diameter (i.e. measure at the root 52 at section D-D of the blades 23), divided by hub 21 outside perimeter “Hp” (in this example the perimeter is measured at the larger diameter of the tapered hub 21 at 0.7*D where “D” is the diameter the blades 23).

In this example, the hub 21 has a relatively large diameter and circumference that results in the solidity ratio being relatively low in comparison, for example, to typical ducted axial fan. The tapered shape of the hub 21 may vary from about, but not limited to, 0.55×D to 0.7×D.

Still referring to FIGS. 10 and 11, it may be appreciated that the angle of attack “AD” of the blade 23 at the root 52 is less than the angle of attack “AA” at the tip 54. In this example, the angle of twist between sections A-A & D-D is between 19 to 23 degrees, the applicable fan diameter “D” sizing may be between about 800 mm & 2000 mm tip diameters, and the blade section radius is between 200 to 500 mm. However, as aforesaid, suitable twist angles may be in the range of about 15 to 30 degrees. It is noted that the sections A-A & D-D are generally “arc” shaped due to the applied twist and the profile of the blades 23 is substantially constant. The “arc” at the root section D-D is greater than the “arc” at the tip section A-A.

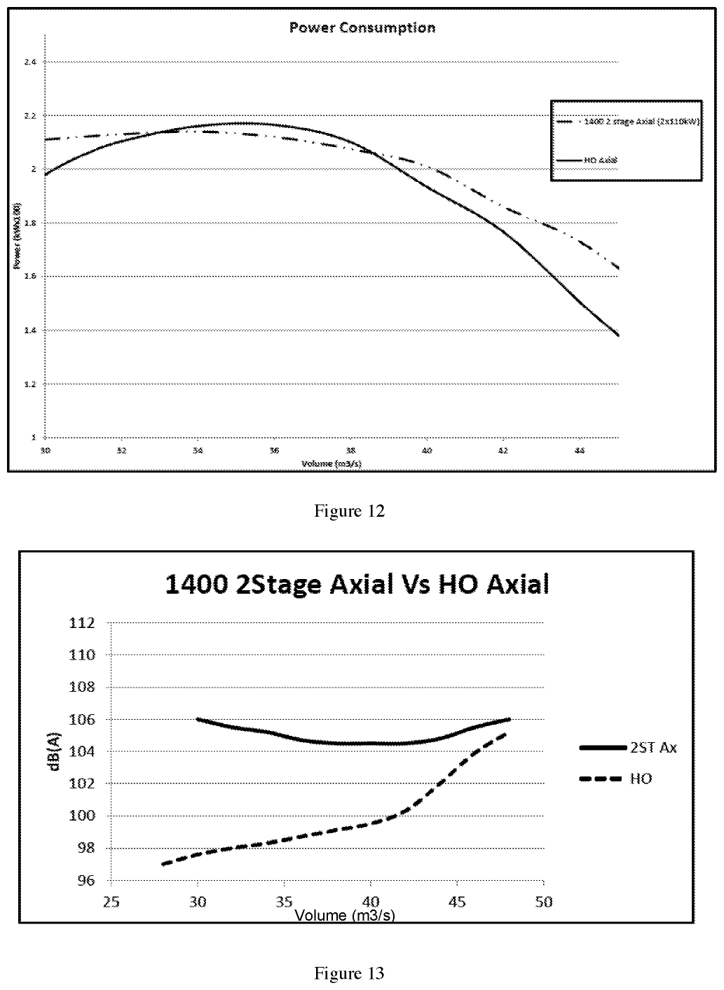

It is also noted that the chord length of the blades 23 is much longer than what is typically used by an impulse bladed impeller and this results in a lower power consumption over the useful range of the impeller, as shown in FIG. 12. Moreover, the longer chord length provides a similar press-volume (PV) curve in comparison to an example axial fan that may be a two-stage axial fan suitable for a duct having a diameter of up to about 1400 mm. Accordingly, the fan arrangement 10 herein is particularly suitable to the duct ventilation market. Noise is also reduced as shown in FIG. 13 in comparison to a two-stage axial fan.

Advantageously, there has been provided a fan arrangement having an impeller is that has an increased chord length, increased number of blades, a relatively high angle of attack of the blades and the flow compression arising from the tapered hub of the impeller. This provides an advantageous fan arrangement having a similar pressure characteristic over a useful range of the fan. The press-volume (PV) curve is also advantageous and suited the vent duct ventilation market and suited to the ducted ventilation system 100 as above described.

Moreover, the fan performance arrangement characteristics mimics the functions of a two-stage axial fan but within a smaller installation envelope thus making the fan lighter and smaller than the comparable axial fans in the market and making installation easier and quicker. The need for less fan installations is also an advantage and results in less installation work whilst using existing cabling. The low end of the pressure volume curve rises higher than the comparable axial fans in the marketplace thus reducing the need for an additional fan, as the duct lengths get longer. The new impeller is smaller in size and features noise reduction characteristics thus noise generation is considerably less that the equivalent single axial fan installation for a given duty.

The impeller blades may be made of plate, rather than aerofoil shaped, thus are not affected by wear. The impeller blade design improvements changes its characteristics from a normally high volume PV (pressure-volume) curve to a steeper lower volume steeper PV curve but with a lower power consumption curve over a wide range of volume flow. The pressure range is substantially higher at the lower end than the comparable fans in the market thus delaying the need for the installation of an additional fan. Fundamentally, the fan arrangement provides a smaller, lighter, quieter, more industrious fan for the same ventilation and pressure range with less resistance meaning less relocations, repairs, safety exposure.

The features that may contribute to overcoming the existing problems are as listed below:
Higher pressures for comparable flows: the combination of blade design features and efficient turning vane design leads to a better pressure rise characteristic than comparable axial fans available in the market;
Weight: as the impeller is smaller in size for a given duty, the weight of the impeller will be less than the comparable axial fan on the market at present
Noise: as the impeller is smaller, the blade tip speeds are smaller and thus the generated noise is less;
Installation costs: as only one fan needs to be installed compared to two standard axial fans for a given duty, the installation time is halved;
Maintenance savings: As the impeller is more robust and less dependent on blade shape for impeller performance, the maintenance requirement intervals are likely to be longer;
OH&S concerns: as wear on the standard axial decreases performance dramatically, the likelihood of impeller failure increases due to stall for a given duct length. The risk of injury due to impeller failure is also increased. The delivered air to the end of the duct will decrease to a point that will be insufficient for the work being performed. As generated noise is less, the exposure to high noise sources will be smaller.
Lower power characteristics: the new impulse bladed fan takes advantage of the available motor power compared to the standard axial fan to deliver more pressure at the lower volume end of the curve and slightly higher volumes at lower pressure requirements. The risk of motor overload is reduced without the need for other control systems.
Less effected by stalling therefore suitable for control using a vane to pre-rotate the flow prior to the impellor allowing a wide range of vane angles to be used whilst the impellor speed is maintain constant.

Finally, it is noted that with this new impeller design makes the fan smaller than existing fans for the same duty and may be lighter in weight by up to 25%. The improved performance may delay the need for additional fans for longer ducts lengths. These features may also simplify installation and improve the OH&S as well as being able to use existing wiring. The power characteristic is largely lower for the practical range of duties that the fan is designed for, thus overloading of the fan motor is alleviated.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any known matter or any prior publication is not, and should not be taken to be, an acknowledgment or admission or suggestion that the known matter or prior art publication forms part of the common general knowledge in the field to which this specification relates.

While specific examples of the invention have been described, it will be understood that the invention extends to alternative combinations of the features disclosed or evident from the disclosure provided herein.

Many and various modifications will be apparent to those skilled in the art without departing from the scope of the invention disclosed or evident from the disclosure provided herein.

1. A system for providing ventilation to a ventilated location within a passageway, the system including:
a duct arranged to extend between an inlet location to an outlet location proximate the ventilated location;
an axial fan fitted with the duct having a motor and an impellor adapted move air between the inlet location and the outlet location, the impellor being an impulse bladed impellor having blades with a substantially constant thickness across a cord of the blades;
a plurality of controllable radial vanes located within the duct relatively upstream of the impellor;
a sensor located relatively downstream of the impellor adapted to provide a measurement indicative of a volumetric flow rate discharged from the outlet location; and
a controller in operative communication with the motor, sensor and the plurality of controllable radial vanes, the controller being configurable to operate the impellor at a predetermined constant speed and maintain the volumetric flow rate above a pre-determined minimum volumetric flow rate by moving the plurality of controllable radial vanes through angles in the range of at least about plus 20 degrees to minus 20 degrees.

2. The system according to claim 1, wherein the sensor is located at or proximate an outlet of the duct.

3. The system according to claim 1, wherein the sensor is adapted to measure flow velocity and the controller is configured to calculate the volumetric flow rate based on the diameter of the duct.

4. The system according to claim 1, wherein the sensor is or includes a pitot tube or annubar.

5. The system according to claim 1, wherein each of the blades of the impellor have a substantially constant thickness across the chord and a length between a root and tip thereof.

6. The system according to claim 1, wherein the diameter of the impellor is substantially similar to that of the duct.

7. The system according to claim 1, wherein the plurality of controllable radial vanes are located immediately upstream of the impellor, the plurality of controllable radial vanes being pivotally moveable via an actuator in operative communication with the controller.

8. The system according to claim 7, wherein the plurality of controllable radial vanes are controllably moveable to an angle to generate a pre-swirl of airflow in a same direction as a rotation direction of the impellor thereby reducing the volumetric flow rate.

9. The system according to claim 7, wherein the plurality of controllable radial vanes are controllably moveable to an angle to generate a pre-swirl of airflow in an opposing direction to a rotation direction of the impellor thereby increasing the volumetric flow rate.

10. The system according to claim 1, wherein the plurality of controllable radial vanes are able to be angled between a range of about plus 30 degrees to minus 30 degrees.

11. A system for providing ventilation to a ventilated location within a passageway, the system including:
a duct arranged to extend between an inlet location to an outlet location proximate the ventilated location;
an axial fan fitted with the duct having an impellor adapted move air between the inlet location and the outlet location, the impellor being arranged to operate at a fixed rotational speed;
a controllable vane located within the duct relatively upstream of the impellor;
a sensor located relatively downstream of the impellor adapted to measure a flow velocity within the duct toward the outlet location; and
a controller in operative communication with the sensor and the vane, the controller being configurable to determine the volumetric flow rate based in the flow velocity and control the vane to maintain the volumetric flow rate above a pre-determined minimum volumetric flow rate whilst maintaining the impellor at the fixed rotational speed.

12. A system for providing a ventilation flow between a first location in a passageway and a second location in the passageway, the system including:
A duct arranged to extend between an inlet location and an outlet location proximate the first location;
An axial fan adapted to move air between the inlet location and the outlet location so as to generate the ventilation flow in the passageway between the first location and the second location;
A controllable vane located within the duct relatively upstream of the axial fan;
A sensor located relatively downstream of the axial fan within the duct, the sensor being adapted to provide a measurement indicative of volumetric flow rate, and
A controller in operative communication with the vane and the sensor,
wherein the controller and sensor are configured such that in the presence of the object between the first location and the second location a change in volumetric flow rate is detectable by the sensor indicative of the presence of the object and the vane is actuable to maintain the volumetric flow rate between the first location and second location above a pre-determined minimum volumetric flow rate.

13. A method for providing ventilation to a ventilated location within a passageway, the method including:
Measuring, relatively down stream of an axial fan within an air supply duct arranged to supply ventilation to the passageway, a parameter indicative of a volumetric flow rate discharged to the ventilated location; and
Selectively moving a control vane located relatively upstream of the axial fan the vane so at to maintain the volumetric flow rate above a pre-determined minimum volumetric flow rate.

14. A method for providing ventilation to a ventilated location within a passageway, the method including:
Measuring, using a sensor located relatively down stream of an axial fan within an air supply duct arranged to supply ventilation to the passageway, a parameter indicative of a measured volumetric flow rate discharged to the ventilated location;
Determining, using at least one of the sensor and a control system, based on the parameter, the measured volumetric flow rate;
Comparing, using the control system, the measured volumetric flow rate with a pre-determined minimum volumetric flow rate; and
Operating a control vane in operative communication with the control system, the control vane being located relatively upstream of the axial fan within the supply duct so as to maintain the volumetric flow rate above a pre-determined minimum volumetric flow rate.

15. A method for maintaining a pre-determined volumetric ventilation condition to a closed end of a passageway in the presence of a removable object in the passageway located between the closed end and an open end of the passageway, the method including:
Supplying ventilation air using a duct having a ducted axial fan arranged to discharge air proximate the first location toward a closed end of the passage,
Measuring, using a sensor located relatively downstream of the axial, a flow parameter usable to determine a measured volumetric flow rate discharged to the first location;
Determining, using at least one of the sensor and a control system, based on the parameter, the measured volumetric flow rate, a change in the measured volumetric flow rate being indicative of the removable object being at least one or removed and located between the first location and the second location;
Comparing, using the control system, the measured volumetric flow rate with the pre-determined volumetric ventilation including a predetermined minimum and maximum volumetric flow rates; and
Operating a control vane in operative communication with the control system, the control vane being located relatively upstream of the axial fan within the supply duct so as to maintain the volumetric flow rate substantially the pre-determined minimum and maximum volumetric flow rates.

16. A method for providing ventilation to a ventilated location within a passageway, the method including:
Providing a duct arranged to extend between an inlet location to an outlet location proximate the ventilated location;
Providing an axial fan within the duct adapted move air between the inlet location and the outlet location;
Measuring, with a sensor located relatively downstream of the axial fan, a flow conditions usable to determine volumetric flow rate discharged from the outlet location;
Moving a controllable vane located within the duct relatively upstream of the axial fan so as to maintain the volumetric flow rate above a pre-determined minimum volumetric flow rate.

17. A method for providing ventilation to a ventilated location within a passageway, the method including:
Providing a duct arranged to extend between an inlet location to an outlet location proximate the ventilated location;
Providing an axial fan within the duct adapted move air between the inlet location and the outlet location;
Setting, using the control system, a fixed rotation speed of an impellor of the axial fan;
Measuring, with a sensor located relatively downstream of the impellor, a flow conditions usable to determine volumetric flow rate discharged from the outlet location;
Moving a controllable vane located within the duct relatively upstream of the impellor so as to maintain the volumetric flow rate above a pre-determined minimum volumetric flow rate.

18. A system for providing ventilation to a ventilated location within a passageway, the system including:
a duct arranged to extend between an inlet location to an outlet location proximate the ventilated location;
an axial fan fitted with the duct having an impellor adapted move air between the inlet location and the outlet location;
a controllable vane located within the duct relatively upstream of the impellor;
a sensor located relatively downstream of the impellor adapted to provide a measurement indicative of a volumetric flow rate discharged from the outlet location; and
a controller in operative communication with the sensor and the vane, the controller being configurable to determine the volumetric flow rate and control the vane so as to maintain the volumetric flow rate above a pre-determined minimum volumetric flow rate.
